(19) United States
(12) Patent Application Publication
(10) Pub. No.: US 2013/0262665 A1
(43) Pub. Date: Oct. 3, 2013

(54) REMOTE SERVER AND METHOD FOR MANAGING RUNNING STATUS OF REMOTE SERVER

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: XIN-HUA LI, Shenzhen (CN); YU-KAI XIONG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/749,566

(22) Filed: Jan. 24, 2013

(30) Foreign Application Priority Data
Mar. 30, 2012 (CN) 201210089490.8

(51) Int. Cl. H04L 12/26

(52) U.S. Cl. CPC H04L 43/04
USPC 709/224

(57) ABSTRACT

A method for managing running status of a remote server includes the steps of: monitoring a running status of the remote server in response to a monitoring request received from at least one client; obtaining corresponding status data of the remote server; transmitting the obtained status data to the at least one client, receiving a control signal generated by the at least one client according to the status data, and adjusting the running status of the remote server to a normal status according to the control signal.

### BACKGROUND

1. Technical Field

The present disclosure relates to remote controlling technology, and particularly to a remote server and a method for managing a running status of the remote server.

2. Description of Related Art

Since the running status of a remote server may change from time to time, software installed on the remote server periodically or in-timely monitors the running status thereof, and the corresponding status data is sent to at least one client, thereby allowing the client to determine whether the running status of the remote server is normal according to the status data. However, this type of software may unnecessarily occupy a large part of the system memory or the processor's computing capacity, thus decreasing the working efficiency of the remote server.

Therefore, what is needed is a means to solve the problems described above.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of a remote server, in accordance with an exemplary embodiment.

FIG. 2 is a flowchart of a method for managing running status of a remote server, in accordance with an exemplary embodiment.

### DETAILED DESCRIPTION

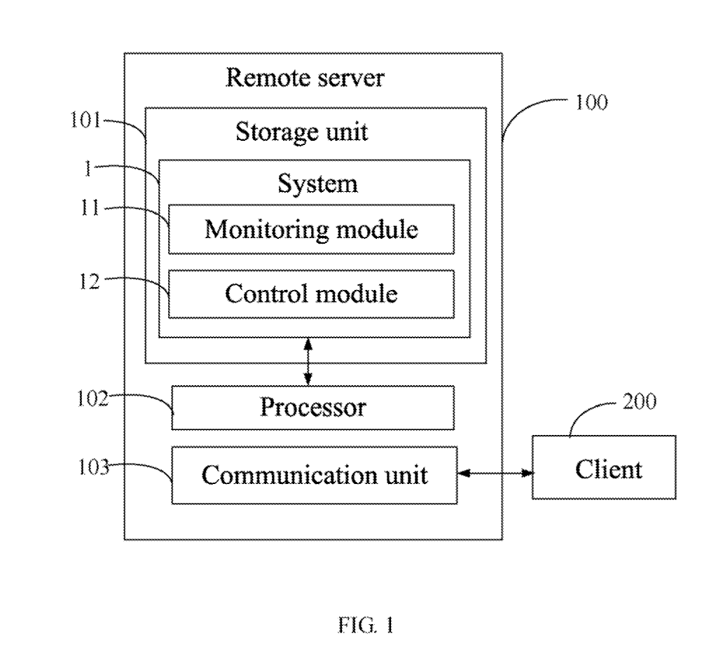

FIG. 1 is a block diagram of a system 1 for managing running status of a remote server 100 according to an exemplary embodiment. Referring to FIG. 1, the remote server 100 includes a storage unit 101, a processor 102, and a communication unit 103. The system 1 is stored in the storage unit 101. The system 1 includes a variety of modules executed by the processor 102 to provide the functions of the system 1. The remote server 100 can communicate with at least one client 200 via the communication unit 103. The communication unit 103 may be a wireless access port or a wired access port. The communication between the remote server 100 and the client 200 through the communication unit 103 may be carried out via any suitable network protocol such as TCP/IP, Bluetooth, and IEEE 802.11. In the embodiment, the system 1 includes a monitoring module 11 and a control module 12.

The monitoring module 11 monitors the running status of the remote server 100 in response to a monitoring request received from at least one client 200 via the communication unit 103. In the embodiment, the client 200 firstly sends a connecting request to the remote server 100, and determines whether the remote server 100 is running according to feedback signals from the remote server 100. If so, the client 200 sends the monitoring request to the remote server 100 to direct the remote server 100 to monitor its running status. In the embodiment, the status data includes characteristic of at least one electronic component of the remote server 100, for example, the temperature of a CPU, the available capacity of a memory, or the rotate speed of a fan.

The control module 12 transmits the obtained status data to the client 200 via the communication unit 103, thereby allowing the client 200 to generate a control signal according to the obtained status data and transmit the control signal to the remote server 100. In the embodiment, the status data transmitted via the communication unit 103 is of XML data type. Specifically, the client 200 stores a variety of standard parameters indicating normal running status of the electronic components of the remote server 100. The client 200 compares the obtained status data with the corresponding standard parameter. If the difference between the obtained status data and the standard parameter falls outside of a predetermined range, the client 200 determines that the running status of the remote server 100 is abnormal, and then generates the control signal to the remote server 100 to direct the remote server 100 to adjust its running status.

The control module 12 adjusts the running status of the remote server 100 according to the control signal, thereby allowing the remote server 100 to run under a normal status.

In the embodiment, the system 1 is an auto-running software which operates when the remote server 100 is running, thereby allowing the variety of the modules of the system 1 to perform the above function.

The system 1 only monitors the running status of the remote server 100 in response to a monitoring request from the client 200, so as to avoid occupying a large part of the system memory or the processor bandwidth. Thus, the working efficiency of the remote server 100 can be significantly improved.

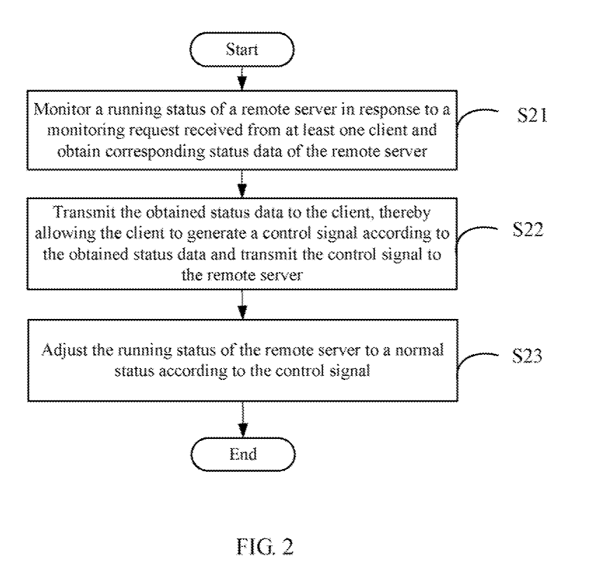

FIG. 2 is a flowchart of a method for managing running status of a remote server 100, in accordance with an exemplary embodiment.

In step S21, the monitoring module 11 monitors the running status of the remote server 100 in response to a monitoring request received from at least one client 200 via the communication unit 103. In the embodiment, the status data includes characteristic of at least one electronic component of the remote server 100, for example, the temperature of a CPU, the available capacity of a memory, or the rotate speed of a fan.

In step S22, the control module 12 transmits the obtained status data to the client 200 via the communication unit 103, thereby allowing the client 200 to generate a control signal according to the obtained status data and transmit the control signal to the remote server 100. In the embodiment, the status data transmitted via the communication unit 103 is of XML data type.

In step S23, the control module 12 adjusts the running status of the remote server 100 according to the control signal, thereby allowing the remote server 100 to run under a normal status.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A remote server communicating with at least one client, the remote server comprising:
a storage unit storing a plurality of modules; and
a processor to execute the plurality of modules;
wherein the plurality of modules comprises:
a monitoring module to monitor a running status of the remote server in response to a monitoring request received from the at least one client and obtain corresponding status data of the remote server; and
a control module to transmit the obtained status data to the at least one client, receive a control signal generated by the at least one client according to the status data, and adjust the running status of the remote server to a normal status according to the control signal.

2. The remote server of claim 1, wherein the plurality of modules are auto-running software which starts to operate when the remote server is running.

3. The remote server of claim 1, wherein the status data comprises characteristic of at least one electronic component of the remote server.

4. The remote server of claim 1, wherein the status data transmitted by the communication module is of XML data type.

5. A method for managing running status of a remote server, the method comprising:
monitoring a running status of the remote server in response to a monitoring request received from at least one client and obtain corresponding status data of the remote server;
transmitting the obtained status data to the at least one client; and
receiving a control signal generated by the at least one client according to the status data, and adjusting the running status of the remote server to a normal status according to the control signal.

6. A storage medium storing a plurality of modules, the plurality of modules comprising instructions executable by a processor of a remote server to perform a method for managing running status of the remote server, the method comprising:
monitoring a running status of the remote server in response to a monitoring request received from at least one client and obtain corresponding status data of the remote server;
transmitting the obtained status data to the at least one client; and
receiving a control signal generated by the at least one client according to the status data, and adjusting the running status of the remote server to a normal status according to the control signal.
